(19) United States
(12) Patent Application Publication
(10) Pub. No.: US 2014/0087839 A1
(43) Pub. Date: Mar. 27, 2014

(54) System for implementing commercial electronic games and method of their development

(71) Applicant: Volodymyr Kolomiiets, Cherkassy (UA)

(72) Inventor: Volodymyr Kolomiiets, Cherkassy (UA)

(21) Appl. No.: 13/624,394

(22) Filed: Sep. 21, 2012

(51) Int. Cl. A63F 13/12

(52) U.S. Cl. 463/25

(57) ABSTRACT

The system for implementing electronic commercial games and method for their development are disclosed. The system relates to methods for developing commercial electronic games and system for implementing them and may be used for implementing games such as lotteries, sweepstakes, and games based on stock trading principles through the use of the internet, mobile connections, terminals, and other means for displaying and transferring data.

### TECHNICAL FIELD

The invention relates to methods for developing commercial electronic games and systems for their implementation that can be used for conducting games such as lotteries, sweepstakes, and games based on exchange trading principle using the Internet, mobile connections, terminals, and other means of displaying and transmitting data.

### BACKGROUND

A known method for implementing a numerical electronic lottery, characterized by an internet server that preliminarily stores a list of serial numbers used in the lottery in the form of sequence of digits, after which the internet server accepts, up until the start of the lottery drawing, signals from participants via their communications links and terminals containing a combination of 4 digits A and B or of 3 digits A, B, and C and stores the provided information in the internet server's memory in corresponding groups A or B, or A, B, and C, then during the drawing the information containing the digits is extracted from the memory and then the digits are subjected to an addition operation in their groups, transmitting this process through internet channels and storing them in memory the resulting sums S1, S2 or S1, S2, and S3, then retrieving from memory the information containing participating serial numbers from the list and conducting a comparison of the last digits in the serial numbers with the calculated sums S1, S2, or S1, S2, and S3 and the serial numbers with matching digits are selected and announced on the website as the first group of winners, followed by a multiplication operation on the sums S1, S2 or S1, S2, and S3, obtaining their product G, store it in the memory and then conduct a comparison of the sequence of digits of the derived number G and the sequence of digits of the participating serial numbers from the list and the serial number where the greatest amount of consecutive digits match the consecutive digits of number G—the result is displayed and this serial number is declared the main winner of the lottery on the website (patent application No 2010111607, Author: Gertner D. A. (RU), date published Sep. 27, 2011).

A known system for implementing a ticket-based lottery, which includes a draw center, connected by two-way internet access to an SMS-center and payment system, and contains a control module with a control interface, where the control module has two-way access to the database of lottery participant information, and has two-way access to the module that manages the prize fund and distribution of the winnings, while the draw center is comprised of at least one module to process SMS-messages, an interface for receiving lottery bets over the internet, both connected by two-way communication lines to the control module, moreover the connection between the draw center and the SMS-center is carried out by the module that processes SMS-messages, and the connection between the draw center with the payment system is done through the module managing the prize fund and distributing winnings, and the module processing SMS-messages is connected by two-way communication lines to the database of SMS-messages. The aforementioned system includes sending information about the lottery to participants, each participant sending at least one paid SMS-message or internet message with a numeric or alphanumeric code to one of the specified telephone numbers of the lottery organizer or to an email/web address on the internet during the specified time period, forming the prize fund, conducting the lottery drawing and distributing the winnings. The winners are determined through the use of a random number generator (Patent RU (11) 2382668 (13) C2 Voronkin D. V., Korobov S. A.).

The disadvantages of the above methods are their fundamental similarity to other types of games like lotteries, which are outdated and do not arouse much interest amongst players.

A known method for administering social games, achieved by means of sending text, graphics, audio, video or visually coded messages, sending SMS, MMS, voice, tone, and USSD messages or via internet through the use of subscriber terminals with subsequent allocation of information on an internet server with the ability to display it on websites, and data is collected, stored, and analyzed on a special server using corresponding software, after which an output in the form of one or several results of the collective move will be sent to the terminals of participants of the competition. (Savchuk O. L., Ukrainian Patent No UA53747). This method will be used as a prototype for forming collective moves (thoughts).

The basis of the proposed invention is the goal of creating a system for administering commercial electronic games and a method for operating them, which provides participants the ability to adjust the game results through a combination of stock trading principles, bets, sweepstakes and lottery games, which gives participants a greater ability to influence the end result of the game, increases their interest in such games and allows players to develop certain intellectual abilities through the need to predict groupthinking, which would help the player achieve the desired result.

### SUMMARY

The described system for implementing commercial games and the method for developing them includes an SMS-center, an interface for receiving bets over the internet, and a payment system, which has a two-way connection to the draw center. The draw center contains a module for managing the prize fund, data visualization module, control module, database of participants and data processing module. Players, using various methods of communication, send signals, which contain combinations of numeric and/or graphic symbols, that are entered into the quotation list on the game operator's server and are stored and analyzed using the data processing module. At the same time, a list of game participants is created and stored in the database of participants. The data processing module calculates elements of combinations of numeric and/or graphic symbols and distributes them by totals into corresponding groups, after which results of the calculations are directed to the data visualization module, which displays the results of the collective move in the form of tables on the participant's terminals or web pages. The described system is unique because it includes a data correction module, which has two-way connection with the SMS-center, interface for receiving bets over the internet, and module for visualizing draw center data, and one-way connection with the data processing module. Also, the data processing module, after counting the received data, sends the results to the data correction module. The data correction module stores the results sent from the data processing module and identifies them as input data for correction. The data correction module is a system for conducting trades, which consist of numeric and/or graphic symbols, the quantity of which is determined by the data processing module, which counts the elements of combinations from signals sent by the players. Through the correction module, players are familiarized with the results produced by the data visualization module and correct those results by increasing or decreasing the number of symbols by sending signals with number and/or graphic symbol combinations, after which the data correction module calculates the frequency of each symbol in registered combinations of game participant's numeric and/or graphic symbols and determines the combinations with the greatest incidence of symbols, which were elements present in the signals containing combinations of numeric and/or graphic symbols that were sent by players.

The technical result of the stated system for implementing commercial games is the use in electronic commercial games of the data correction module, which operates on the principle mechanism for implementing trades with consideration for the collective moves of game participants, which provides participants the ability to correct the game's results and contains within it a learning function that serves as training, based on the game, which uses the effects of entertainment and financial motivations with the aim of developing intellectual abilities in players through necessary foresight of groupthinking, which allows them to achieve the desired results.

### DESCRIPTION OF DRAWINGS

FIG. 1 is an illustration of a system for implementing commercial electronic games in accordance with the present invention.

### DETAILED DESCRIPTION

The proposed system for administering commercial electronic games and the method for operating them includes an SMS-center, interface for accepting bets over the internet, payment system, which has a two-way communication link with the draw center. The draw center contains a module for managing a prize fund, module for visualizing data, control module, database of participants and a module for processing data. Players, using various methods of communication, send signals, which contain combinations of numeric and/or graphic symbols, that are entered into the quotation list on the game operator's server and are stored and analyzed using the data processing module. At the same time, a list of game participants is created and stored in the database of participants. The data processing module calculates elements of numeric combinations and/or graphic symbols and distributes them by totals into corresponding groups, after which results of the calculations are directed to the data visualization module, which displays the results of the collective move in the form of tables on the participant's terminals or web pages. The proposed system differs because it includes an additional module for correcting data, which has a two-way connection with the SMS-center, the interface for receiving bets over the internet, the data visualization module of the game operator's draw center, and a one-way connection with the data processing module. Also, the data processing module, after counting the received data, sends the results to the data correction module. The data correction module stores the results sent from the data processing module and identifies them as input data for correction. The data correction module is a system for conducting trades, where trade subjects consist of numeric and/or graphic symbols, the quantity of which is determined by the data processing module, which counts the elements of combinations from signals sent by the players. Through the correction module, players are familiarized with the results produced by the data visualization module and correct those results by increasing or decreasing the number of symbols by sending signals with number and/or graphic symbol combinations, after which the data correction module calculates the frequency of each symbol in registered combinations of game participant's numeric and/or graphic symbols and determines the combinations with the greatest incidence of symbols, which were elements present in the signals containing combinations of numeric and/or graphic symbols that were sent by players.

The control module is linked by a two-way connection with the data visualization module, participant database, data processing module, and the data correction module of the draw center.

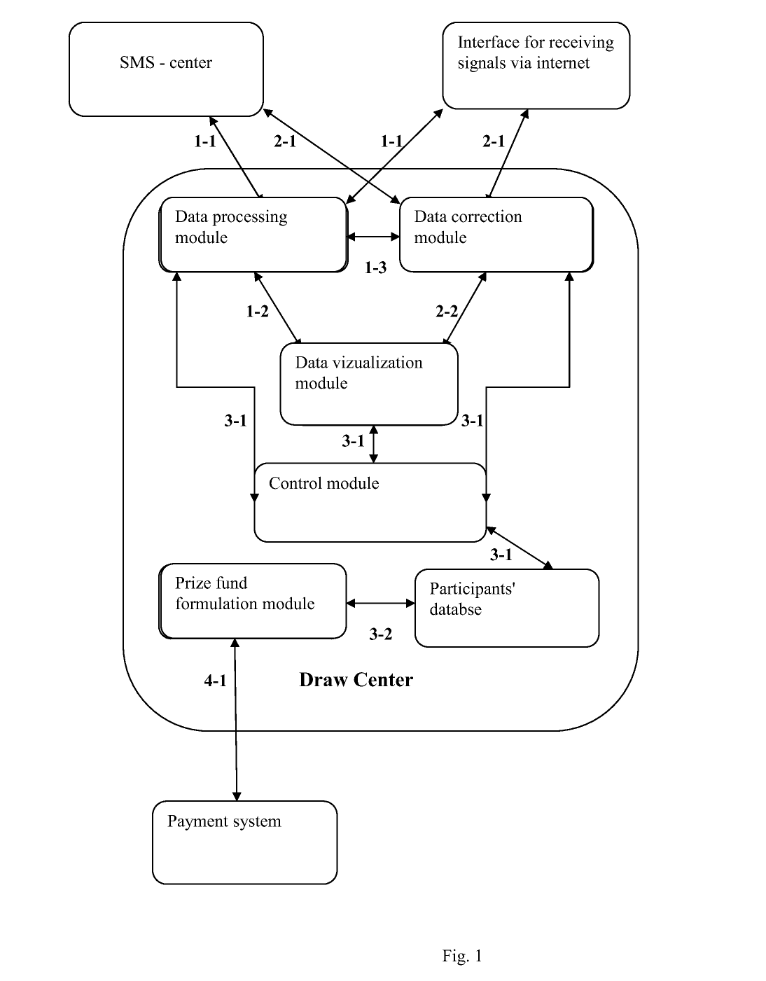

In FIG. 1 is a schematic of the interaction of elements of the stated system for implementing commercial electronic games: 1) 1-1. Interaction of the SMS-center and Interface for receiving signals over the internet with the data processing module of the draw center during the participant's process of sending signals with numeric and/or graphic symbol combinations. After which the data processing module conducts an analysis and calculation of the numeric and/or graphic symbols, which were factored into the combinations sent by the game participants, and distributes them by totals into corresponding groups; 2) 1-2. The data processing module sends the results of the analysis and calculation to the data visualization module, which outputs the results in the form of several results of the collective move in tables on participants' terminals or website; 3) 1-3. The data processing module sends results of analysis and calculation for storage to the data correction module, where received data is recognized as data inputted for correction.; 4) 2-1. Interaction between the SMS-center and the Interface for receiving signals over the internet with the data correction module of the draw center. Game participants, familiarized with the results of the game distributed by the visualization module, send signals with numeric and/or graphic symbol combinations with the aim of increasing or decreasing the number of registered symbols. After this the data correction module calculates the frequency of correct hits for each symbol in the game participants' registered numeric and/or graphic symbol combinations; 5) 2-2. The data correction module sends the end result to the data visualization module for display; 6) 3-1. The control modules connection with the data processing module, data visualization module, data correction module, and participant database; 7) 3-2. Connection between the database and prize fund formulation module; 8) 4-1. Connection between the payment system and prize fund formulation module.

The technical result of the stated system for implementing commercial games is the use in electronic commercial games of the data correction module of the draw center, which operates on the principle mechanism for implementing trades with consideration for the collective moves of game participants, which provides participants the ability to correct the game's results and contains within it a learning function that serves as training, based on the game, which uses the effects of entertainment and financial motivations with the aim of developing intellectual abilities in players through necessary foresight of groupthinking, which allows them to achieve the desired results.

A way to transfer data could include the use of a mobile connection, internet, gaming, banking, and other terminals, and other means of data transfer and display.

Practical application of the method can be observed in an example of a number game. The game consists of two stages—passive (closed) and active (open bids). The trading subject consists of numbers from 1 to A, from which the player chooses N numbers, where N—the number of digits contained in the combination (lot), and A—the maximum, as determined by the rules of the game, number quantity in the specific game. In passive trades players can, through various methods of data transfer, send to the game operator's server signals containing combinations of numeric symbols of 1 to N numbers ranging from 1 to A, which are determined by the rules of the game, which are entered into the quotation list on the game operator's server. The data processing module of the game operator's draw center counts the amount of each numeric symbol combination, which were entered into the game operator's server and through the data visualization module outputs a visual result in the form of tables and/or ratings on the participants terminals. Simultaneously, the data processing module directs the specified result to the data correction module, where this result is recognized as data received for correction. For active trades (administered through the data correction module) players, familiarized with preliminary results, correct them by increasing or decreasing the amount of numeric symbols by sending to the game operator's server signals with combinations of numeric symbols from 1 to A in N amounts and in online mode visually observe changes in the quantitative indicators for each symbol. Corrections are made within time limits, determined by the game operator. After conducting passive and active trades, the game operator ceases accepting any signals. After this, the game operator's draw center's data correction module counts the frequency of correct hit for each numeric symbol in the game participant's combinations of numeric symbols and determines which combinations have the greatest incidence of symbols, which were elements present in the signals with combinations of numeric symbols that were sent by players.

The player has the right to create an unlimited amount of combinations of numeric and/or graphic symbols and send the corresponding signals to the game operator's server.

Each participant receives a personal page on the game's website displaying the quantity and time their numeric combinations and/or graphic symbols were registered, financial results, and other information.

Technical solutions that match the set of essential features of this invention have not been found, which permits concluding that the “novelty” condition for patentability has been met.

What is claimed is:

1. (canceled)

2. A system for implementing commercial electronic games, said system comprising an SMS-center, a draw center, an interface for accepting bets over the Internet, which has two-way communication with said draw center, and a payment system; said draw center comprises a data processing module, to which the players, through various means of data transfer, send signals containing combinations of numeric and/or graphic symbols, which are registered, stored, analyzed, and afterwards given to the competition's participants in the form of one or several results of the collective move, and a data correction module, which has two-way connection with the SMS-center, the interface for accepting bets over the internet, and one-way connection with the data processing module; and wherein the data correction module is configured to calculate the frequency of each symbol in registered combinations of game participant's numeric and/or graphic symbols.

3. A system according to claim 2, wherein the draw center further comprising a prize fund management module, a module for distributing winnings, and a data visualization module, which has two-way connection with the data correction module.

4. A system according to claim 3, wherein the data processing module is configured to analyze and calculate the elements of numeric combinations and/or graphic symbols and distribute them by totals to corresponding groups and to direct the results to the data visualization module, which is configured to output the results in the form of a table on the participant's terminal or webpage, and to the data correction module, which is configured to identify the results as input data for correction.

5. A system according to claim 4, wherein the data correction module representing a system for conducting trades of numeric and/or graphic symbols, the quantity of which was determined by the data processing module's calculation of elements of combinations from signals, sent by players, and through which players, familiarized with results, correct them by increasing or decreasing the quantity of symbols by sending signals with combinations of numeric and/or graphic symbols, after which the data correction module calculates the frequency of each symbol in registered combinations of game participant's numeric and/or graphic symbols and determines the combinations with the greatest incidence of symbols, which were elements present in the signals containing combinations of numeric and/or graphic symbols that were sent by players.

6. A system according to claim 2, further comprising a participant database configured to store a list of game participants.

7. A system according to claim 6, further comprising a control module linked by a two-way connection with the data visualization module, the participant database, the data processing modules, and the data correction module of the draw center.

8. A system according to claim 2, wherein the data transfer is conducted by way of a mobile connection, internet, gaming terminals, or banking terminals.

9. A method of implementing commercial electronic games using a system according to claim 4, said method comprising the steps of:
receiving by the data processing module signals with numeric and/or graphic symbol combinations from the SMS center and the interface for accepting bets over the internet;
analyzing and calculating the numeric and/or graphic symbols, which were factored into the combinations sent by the game participants, and distributing them by totals into corresponding groups by the data processing module;
sending by the data processing module the results of the analysis and calculation to the data visualization module;
outputting the results by the data visualization module in the form of several results of the collective move in tables on the participant terminal or website;
sending by the data processing module the results of analysis and calculation for storage to the data correction module, wherein the received data is recognized as data inputted for correction;
calculating the frequency of correct hits for each symbol in the game participants' registered numeric and/or graphic symbol combinations by the data correction module; and
sending the calculated frequency of correct hits by the data correction module to the data visualization module for display.

10. A method according to claim 9, further comprising storing a list of game participants in a participant database.

11. A method of conducting a number game comprising a passive stage and an active stage using a system according to claim 4, said method comprising the steps of:
counting by the data processing module the amount of each numeric symbol combination, which were entered into the game operator's server;
outputting by the data visualization module a visual result in the form of tables and/or ratings on the participants terminals;
directing by the data processing module the visual result to the data correction module, wherein this result is recognized as data received for correction;
counting by the data correction module the frequency of correct hit for each numeric symbol in the game participant's combinations of numeric symbols and determines which combinations have the greatest incidence of symbols, which were elements present in the signals with combinations of numeric symbols that were sent by players.

12. A method according to claim 11, wherein the trading subject consists of numbers from 1 to A, from which the player chooses N numbers, where N is the number of digits contained in the combination (lot), and A is the maximum, as determined by the rules of the game, number quantity in the specific game; wherein in passive trades players can, through various methods of data transfer, send to the game operator's server signals containing combinations of numeric symbols of 1 to N numbers ranging from 1 to A, which are determined by the rules of the game, which are entered into the quotation list on the game operator's server.

13. A method according to claim 11, wherein for active trades administered through the data correction module players, familiarized with preliminary results, correct them by increasing or decreasing the amount of numeric symbols by sending to the game operator's server signals with combinations of numeric symbols from 1 to A in N amounts and in online mode visually observe changes in the quantitative indicators for each symbol.

14. A method according to claim 11, wherein the corrections are made within time limits, determined by the game operator.

15. A method according to claim 11, wherein the player has the right to create an unlimited amount of combinations of numeric and/or graphic symbols and send the corresponding signals to the game operator's server.

16. A method according to claim 11, further comprising creating a personal page for each participant on the game's website displaying the quantity and time their numeric combinations and/or graphic symbols were registered, financial results, and other information.
